(19) United States
(12) Patent Application Publication
(10) Pub. No.: US 2009/0103307 A1
(43) Pub. Date: Apr. 23, 2009

(54) Wireless control lamp structure

(75) Inventor: Tzu-Hua Shu, Taoyuan County (TW)

Correspondence Address: REED SMITH LLP, 3110 Fairview Park Drive, Suite 1400, Falls Church, VA, 22042, US

(73) Assignee: Semiconductor Device Solution, Inc.

(21) Appl. No.: 12/010,295

(22) Filed: Jan. 23, 2008

(30) Foreign Application Priority Data
Oct. 19, 2007 (TW) 096217561
Nov. 19, 2007 (TW) 096219520

(51) Int. Cl. F21V 29/00; H05B 41/36

(52) U.S. Cl. 362/294; 315/291

(57) ABSTRACT

A wireless-control lamp structure comprises a lamp and a wireless control module. The wireless control module is connected in signal communication with a power supply portion of the lamp for receiving a wireless control signal and thereby controlling an actuation of the lamp.

### BACKGROUND OF THE INVENTION

1. Technical Field

The present invention relates to a wireless-control lamp structure, and more particularly to a wireless-control lamp structure for use in illumination, landscape or on a stage.

2. Description of Related Art

Lighting in general cannot do without lamps. Modern lamps not only provide indoor illumination, but also play a major part in creating indoor atmosphere or lighting effects on a stage. By coordinating the styles of lamps and the colors of light emitted therefrom, a stage or an indoor environment can be infused with a certain ambience or mood so as to reflect a particular style and personality, to enhance artistic qualities, and to provide a space that fulfills our psychological and biological needs as well as esthetic preferences. Light-emitting diodes (LED) as a new lighting technology have a prospect of applications that attracts the world's attention.

High-brightness LED's, in particular, have been hailed as the most valuable light source in the twenty-first century. LED's are expected to replace conventional incandescent lamps and fluorescent lamps, presenting a serious challenge to traditional indoor lighting apparatuses. The new light source of LED's has initiated a revolution in lamp design and development, so that the language and concepts in lamp design can be used freely and re-established, and lamps are allowed for more creative presentation in visual perception and forms. As a result, indoor lighting apparatuses are becoming more power-saving, health-oriented, artistic and humanistic.

Conventional lamps are mostly designed to be wire-controlled, where lamps are actuated by controlling the power supplies thereof. In addition to controlling the power supply, actuation of lamps can also be controlled by signal transmission on wires. In either way, however, the wired design increases the complexity of installation. Particularly where control over a long distance is desired, a problem of signal attenuation may arise in addition to the wiring problem. Moreover, the maintenance of wires—and the mess resulting from lack of the maintenance—can be very troublesome as the time of use accumulates.

### SUMMARY OF THE INVENTION

The present invention provides a wireless-control lamp structure so that placement, distribution and installation of a lamp can be made more conveniently due to a wireless control module. In addition, the lamp, when installed, can also be used and controlled more conveniently through wireless signal transmission.

To achieve this end, the present invention provides a wireless-control lamp structure comprising a lamp and a wireless control module connected in signal communication with a power supply portion of the lamp for receiving a wireless control signal and thereby controlling an actuation of the lamp.

In the aforementioned lamp structure, the lamp includes: a first casing having a first receiving space; a light-emitting unit disposed in the first casing and connected in signal communication with the power supply portion; and a transparent substrate combined with the first casing so that the first receiving space forms a closed space.

In the aforementioned lamp structure, the first casing is further combined with a second casing, wherein the second casing has a second receiving space and a support connecting portion.

The present invention can be implemented to at least provide the following advantageous effects:

1. With reduced wiring, the placement, distribution and installation of the lamp can be more convenient.

2. The lamp can be used and controlled more conveniently through wireless signal transmission.

3. The lamp is provided with anti-fog, heat-dissipation and self-cleaning features.

### BRIEF DESCRIPTION OF THE DRAWINGS

FIG. 1 is a perspective view of a wireless-control lamp structure according to the present invention.

FIG. 2 is a perspective exploded view of the wireless-control lamp structure according to the present invention.

FIG. 3 is a cross-sectional view of the wireless-control lamp structure according to the present invention.

FIG. 4 illustrates movement of a lamp in the wireless-control lamp structure according to the present invention.

### DETAILED DESCRIPTION OF THE PREFERRED EMBODIMENT

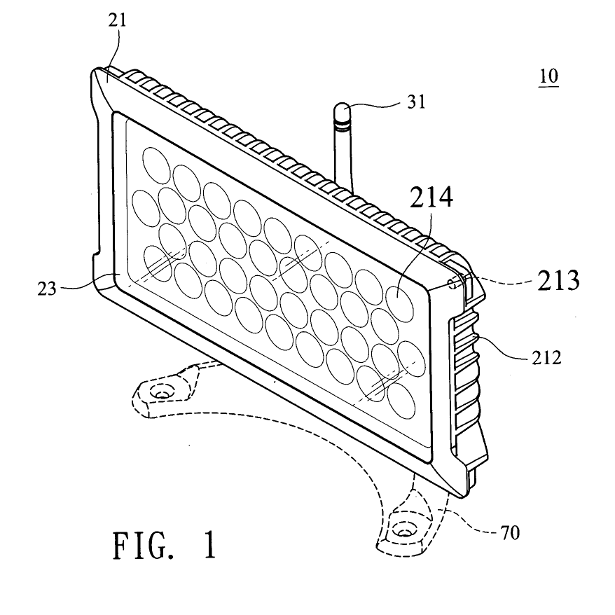

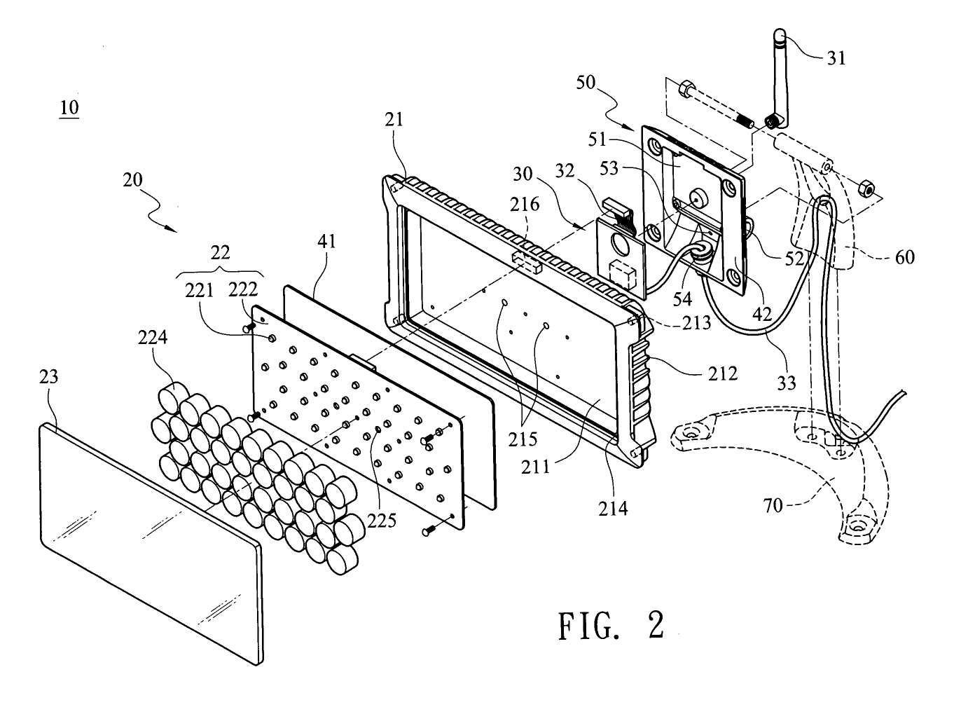

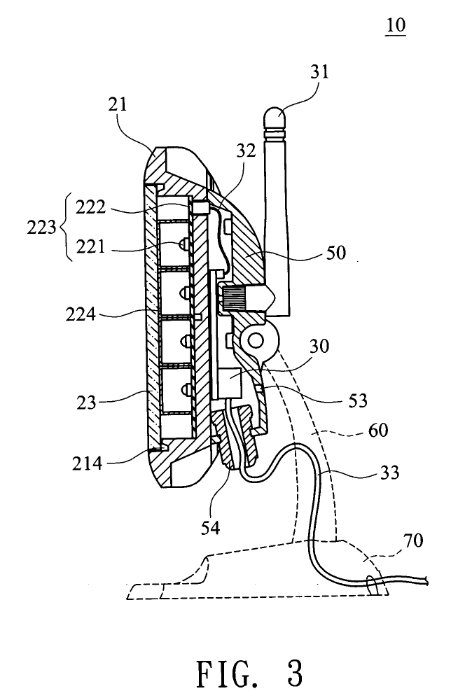

Referring to FIGS. 1, 2 and 3, the embodiment shown therein is a wireless-control lamp structure 10 comprising a lamp 20 and a wireless control module 30.

The lamp 20, which can be a light-emitting diode lamp in particular, includes a first casing 21, a light-emitting unit 22 and a transparent substrate 23.

The first casing 21 has a first receiving space 211. The first casing 21 is made of metal or other materials having good heat conductivity and good structural properties. The first casing 21 is further formed with a plurality of cooling fins 212 on outer side surfaces thereof. Therefore, the first casing 21 serves to conduct as well as to dissipate heat, so that heat generated by the light-emitting unit 22 can be carried away and dissipated successfully. Thus, operation of the lamp 20 will not be affected by problems associated with heat.

The first casing 21 is provided with at least one connecting hole 213 for cooperating with a connecting plate (not shown), so that different lamps 20 can be joined together with screws to form an illuminous body with a larger illumination area. The connecting hole 213 is preferably located at a peripheral end of the first casing 21 to facilitate use of the connecting plate.

The first casing 21 is coated on an outer surface thereof with a Polytetrafluoroethylne baked finish, which has good heat conductivity, to improve heat dissipation of the lamp 20.

The first casing 21 further has a glue filling groove 214 on a periphery of the first receiving space 211. Because the first casing 21 and the transparent substrate 23 are joined together via a gluing substance, the glue filling groove 214 facilitates a glue filling process during assembling and prevents the gluing substance from flowing all over the place. Furthermore, the glue filling groove 214 is useful in increasing a filling uniformity of the gluing substance. As a result, the transparent substrate 23 and the first casing 21 can be joined together more tightly, so that no moisture will penetrate into the lamp 20 after the product is assembled.

The first casing 21 is formed with at least one first vent hole 215, so that, after the lamp 20 is assembled, moisture trapped therein and evaporated by heat generated by the lamp 20 in operation can be released from the lamp 20 through the first vent hole 215. When the evaporated moisture is successfully released, the transparent substrate 23 of the lamp 20 will not have moisture attached thereon, thereby preventing the appearance and quality of the product from being affected by the moisture.

If the first vent hole 215 is covered by a second casing 50, it is not necessary to combine the first vent hole 215 with a waterproof breathable film. However, if the first vent hole 215 is not covered by a second casing 50, the first vent hole 215 must be combined with a waterproof breathable film on an inner side of the first casing 21 so as to cover the first vent hole 215. The waterproof breathable film allows moisture in the lamp 20 to be released outwards but blocks outside moisture from entering the lamp 20.

The first casing 21 is further provided with a connector opening 216, so that lines 32 extending from an output end of the wireless control module 30 can pass through the connector opening 216 and be electrically connected with the light-emitting unit 22, thereby enabling the wireless control module 30 to control an actuation of light-emitting diodes 221.

The light-emitting unit 22 is disposed in the first receiving space 211 of the first casing 21 and electrically connected with the power supply portion. The light-emitting unit 22 is a light plate 223 formed by a circuit board 222 such as a printed circuit board and a plurality of light-emitting diodes 221 installed thereon. Each of the light-emitting diodes 221 can be further combined with a lens 224, wherein different lenses 224 can be used to generate different light fields so as to suit different occasions. The circuit board 222 can be formed with at least one second vent hole 225 to facilitate releasing of moisture trapped between the circuit board 222 and the transparent substrate 23. The second vent hole 225 must be located in correspondence to the first vent hole 215 so that the first and second vent holes 215, 225 are in communication with each other.

The light-emitting unit 22 can be secured in the first receiving space 211 with screws. In order to rapidly discharge heat generated by the light-emitting unit 22, a heat conducting material 41 is provided between the light-emitting unit 22 and the first casing 21. Besides heat transfer pastes, a heat conducting silica gel can also be used as the heat conducting material 41, as in the embodiment of the present invention. The heat conducting silica-gel not only has good heat conductivity but also provides an adhesive and buffering function, so that the light-emitting unit 22 and the first casing 21 can be bonded more securely. When the heat conducting material 41 is a plate made of heat conducting silica-gel, the heat conducting silica-gel plate must also be formed with a hole located in correspondence to the first vent hole 215 and the second vent hole 225 for the holes to be in communication with one another.

The transparent substrate 23 is combined with the first casing 21 so that the first receiving space 211 forms a closed space. The transparent substrate 23 can be a glass substrate or an acrylic substrate. The transparent substrate 23 can be further coated with a TiO₂ photocatalyst coating or a nano photocatalyst low-emissivity plating.

Photocatalyst is capable of decomposing grease and therefore widely used as a coating on glass, ceramics, plastic, etc. for providing a self-cleaning function, reducing cleaning efforts, and preventing fogging and condensation in rainy days. With a photocatalyst coating, the transparent substrate 23 can be made more light-transmissive and clear.

In addition, a TiO₂ photocatalyst is antimicrobial and can be used to eliminate mildew, bacteria and viruses and remove unpleasant odors, so as to make offices, homes or other indoor spaces more healthy and safer and bring about fresher and cleaner air.

Furthermore, a nano photocatalyst low-emissivity plating is highly reflective to visible light and heat rays and absorbs ultra-violet rays. A high reflection to visible light provides the transparent substrate 23 with the effect of a mirror while light reflected from and transmitted through the transparent substrate 23 gives light emitted from the lamp a natural color tone.

In particular, a tempered glass, a self-cleaning glass or an anti-fog glass can be used as the transparent substrate 23. A tempered glass is safer to use, handle and assemble. A self-cleaning glass provides a glass surface that is not easily contaminated by pollutants in the environment. An anti-fog glass can prevent a foggy glass surface due to a temperature difference between the lamp in operation and the environment. With the various types of transparent substrate 23 mentioned above, a light beam projected from the lamp can be rendered closer to an intended effect, and a quality of the light beam will not be impaired as the time of use accumulates or as the environment changes.

The wireless control module 30 is connected in signal communication with a power supply portion of the lamp 20, wherein the power supply portion serves mainly to transform an alternate current power supply into a direct current power supply. The wireless control module 30 is used to receive a wireless control signal and controls an output of direct currents according to the wireless control signal, thereby controlling the actuation of the lamp 20.

When the lamp 20 in this embodiment is used in stage lighting, signal transmission and control of the wireless control module 30 can be conducted according to a DMX512 communication protocol in order to generate the rich lighting effects on a stage. In this case, the remote control module 30 is a wireless control module 30 based on the DMX512 communication protocol.

Furthermore, the wireless control module 30 in this embodiment is a frequency-hopping wireless control module 30 that uses a frequency hopping technology so as to operate more stably without interference from ambient noises.

Moreover, for the purpose of energy saving or in order to be used in a security system, the wireless control module 30 can further has an infrared-sensing detector connected in signal communication with an infrared controller, wherein the infrared controller is connected in signal communication with the power supply portion for controlling the actuation of the lamp 20. The lamp 20 is switched on or off depending on whether the infrared-sensing detector has identified a human temperature within a specified area.

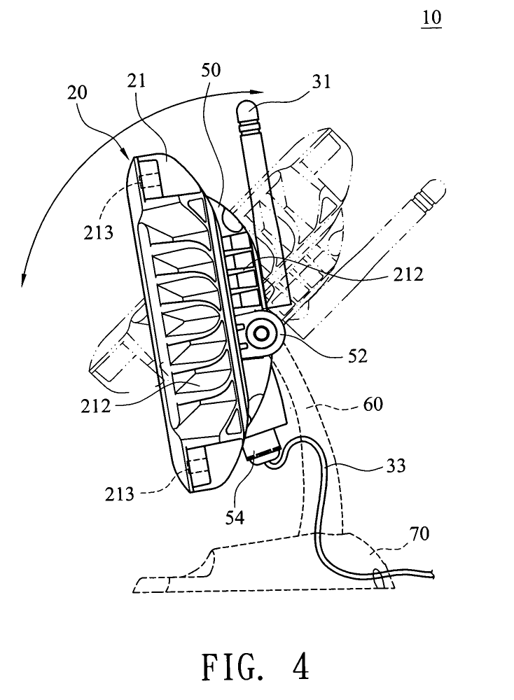

Referring to FIG. 4, in the aforementioned structure of the lamp 20, the first casing 21 is further combined with a second casing 50, wherein the second casing 50 is made of the same material as the first casing 21. The second casing 50 has a second receiving space 51 and a support connecting portion 52, wherein the support connecting portion 52 is used to connect with a support 60 and a base 70 so that the lamp 20 can be easily installed. In order for the lamp 20 to project light at different angles, the support connecting portion 52 and the base 70 can be joined via a hinge or in the form of a ball (not shown).

If the lamp structure 10 is further provided with the second casing 50, the wireless control module 30 can be disposed in the second receiving space 51 while an antenna 31 of the wireless control module 30 can also be fixedly attached to the second casing 50. A joining portion between the first casing 21 and the second casing 50 can be made tighter and moisture impermeable by applying a waterproof glue 42 to the joining portion. The waterproof glue is preferably a heat conducting silica gel so that heat on the first casing 21 can be more quickly conducted to the second casing 50 for more effective heat dissipation.

The second casing 50 can further include at least one third vent hole 53 for successfully releasing moisture from the second receiving space 51, wherein the third vent hole 53 is combined with a waterproof breathable film on an inner side of the second casing 50 so as to cover the third vent hole 53, thereby preventing moisture from entering the second receiving space 51 through the third vent hole 53.

A fixing terminal 54 is located where power supply cords 33 enter the second casing 50. The fixing terminal 54 can fix the power supply cords 33 and prevent them from being disengaged from the wireless control module 30 when the power supply cords 33 are pulled. The fixing terminal 54 can also be tightly combined with an insulating outer surface of the power supply cords 33 to prevent moisture from entering the second casing 50.

It should be noted that the aforementioned embodiment is described to demonstrate features of the present invention so that a person skilled in the art can understand the content of the present invention and put it into practice, and the embodiment is not intended to limit the scope of the present invention. Therefore, all equivalent modifications or alterations that do not depart from the spirit of the present invention are encompassed by the appended Claims.

What is claimed is:

1. A wireless-control lamp structure, comprising:
a lamp; and
a wireless control module, connected in signal communication with a power supply portion of the lamp for receiving a wireless control signal and thereby controlling an actuation of the lamp.

2. The lamp structure as claimed in claim 1, wherein the lamp is a light-emitting diode lamp.

3. The lamp structure as claimed in claim 1, wherein the wireless control module is a frequency-hopping wireless control module, or a wireless control module using a DMX512 communication protocol.

4. The lamp structure as claimed in claim 1, further comprising an infrared-sensing detector connected in signal communication with an infrared controller, wherein the infrared controller is connected in signal communication with the power supply portion for controlling the actuation of the lamp.

5. The lamp structure as claimed in claim 1, wherein the lamp includes:
a first casing, having a first receiving space;
a light-emitting unit, disposed in the first casing and electrically connected to the power supply portion; and
a transparent substrate, combined with the first casing so that the first receiving space forms a closed space.

6. The lamp structure as claimed in claim 5, wherein the first casing is formed with a plurality of cooling fins.

7. The lamp structure as claimed in claim 5, wherein the first casing is formed with at least one connecting hole.

8. The lamp structure as claimed in claim 5, wherein the first casing has a Polytetrafluoroethylne baked finish on an outer surface thereof.

9. The lamp structure as claimed in claim 5, wherein the first casing has a glue filling groove on a periphery of the first receiving space.

10. The lamp structure as claimed in claim 5, wherein the first casing is formed with at least one first vent hole.

11. The lamp structure as claimed in claim 5, wherein the first casing is formed with at least one first vent hole, and the first vent hole is combined with a waterproof breathable film on an inner side of the first casing.

12. The lamp structure as claimed in claim 5, wherein the light-emitting unit is a light plate formed by a circuit board and a plurality of light-emitting diodes installed thereon.

13. The lamp structure as claimed in claim 5, wherein the light-emitting unit is a light plate formed by a circuit board and a plurality of light-emitting diodes installed thereon, and each of the plurality of light-emitting diodes is combined with a lens.

14. The lamp structure as claimed in claim 12, wherein the circuit board is formed with at least one second vent hole.

15. The lamp structure as claimed in claim 5, wherein a heat conducting material or a heat conducting silica gel is disposed between the light-emitting unit and the first casing.

16. The lamp structure as claimed in claim 5, wherein the transparent substrate is a glass substrate or an acrylic substrate.

17. The lamp structure as claimed in claim 5, wherein the transparent substrate is further coated with a TiO₂ photocatalyst coating or a nano photocatalyst low-emissivity plating.

18. The lamp structure as claimed in claim 5, wherein the transparent substrate is a tempered glass or a self-cleaning glass or an anti-fog glass.

19. The lamp structure as claimed in claim 5, wherein the transparent substrate is a self-cleaning glass.

20. The lamp structure as claimed in claim 5, wherein the first casing is further combined with a second casing, and the second casing has a second receiving space and a support connecting portion.

21. The lamp structure as claimed in claim 20, wherein the wireless control module is disposed in the second receiving space.

22. The lamp structure as claimed in claim 20, wherein a waterproof glue or a heat conducting silica gel is applied to a joining portion between the first casing and the second casing.

23. The lamp structure as claimed in claim 20, wherein the second casing is formed with at least one third vent hole, and the third vent hole is combined with a waterproof breathable film on an inner side of the second casing.
